(19) United States
(12) Patent Application Publication
(10) Pub. No.: US 2026/0287927 A1
(43) Pub. Date: Sep. 24, 2026

(54) HINGE ASSEMBLIES FOR SMART EYEWEAR APPARATUS

(71) Applicant: IXI Eyewear Oy, ESPOO (FI)

(72) Inventors: Timo Yliluoma, Helsinki (FI); Otto Huittinen, Vantaa (FI)

(73) Assignee: IXI Eyewear Oy, ESPOO (FI)

(21) Appl. No.: 19/682,292

(22) Filed: May 19, 2026

Related U.S. Application Data
(63) Continuation-in-part of application No. 18/489,089, filed on Oct. 18, 2023.

(51) Int. Cl. G02C 5/22

(52) U.S. Cl. CPC G02C 5/2218

(57) ABSTRACT

Disclosed is a hinge assembly (100, 208a, 208b, 500, 600) for smart eyewear apparatus (200), comprising: rotating member (102, 302); first hinge (104) hingedly couples frame (202, 604) to rotating member, first hinge provides rotation of frame about first rotational axis (106); second hinge (108) hingedly couples with temple (206a, 206b) to rotating member, second hinge provides rotation of temple about second rotational axis (110); frame attachment part (112, 404, 602) couples rotating member to frame; temple attachment part (114, 408) couples rotating member to temple; cam arrangement (136, 400) comprising: (i) first cam surface (138, 402), (ii) second cam surface (140, 406); spring (116, 304, 410) arranged concentrically around first hinge, rotation of temple causes relative sliding between first cam surface, second cam surface and loads spring, loaded spring applies spring force to rotating member to hold temple in one of: first angular position, second angular position.

### TECHNICAL FIELD

The present disclosure relates to hinge assemblies for smart eyewear apparatuses. The present disclosure also relates to smart eyewear apparatuses.

This is continuation in part of XXXX which is incorporated here in its entirety.

### BACKGROUND

Eyewear has traditionally been used to aid or correct vision, protect the eyes from sunlight, dust, debris, and harmful radiation, and provide a desired appearance to a wearer. With development of smart wearable devices, a smart eyewear apparatus may also include electronic features such as visual display, sensing, adaptive optical control, communication, and health-related monitoring. In the smart eyewear apparatus, electronic functionality is usually supported by electrical components, a power source, and electrical connections arranged within or around portions of the smart eyewear apparatus. Since the smart eyewear apparatus is worn on the face and repeatedly opened, closed, handled, and stored, arrangement of mechanical parts and electrical parts is important for maintaining comfort, durability, safety, and appearance.

Conventionally, the electrical components in the smart eyewear apparatus is powered using an external wire routed along a frame. However, the external wire often exposed to moisture, dust, sweat, temperature changes, and accidental pulling, thereby reducing durability and reliability. Further, the external wire usually snags on hair, skin, clothing, or nearby objects, causing discomfort and possible damage. In another conventional approach, the wire may be routed inside a portion of the smart eyewear apparatus to hide the wire from view. However, such internal routing of the wire may still be difficult near moving portions of the smart eyewear apparatus, where repeated opening and closing may bend, twist, pinch, or strain the wire. Therefore, conventional smart eyewear technologies are not adequately able to maintain electrical reliability, mechanical durability, user comfort, and compact appearance when the electrical components are integrated into the smart eyewear apparatus.

Therefore, in light of the foregoing discussion, there exists a need to overcome the aforementioned drawbacks.

### SUMMARY

The aim of the present disclosure is to provide a hinge assembly and a smart eyewear apparatus to improve positional stability, controlled movement, electrical reliability, and durability within the smart eyewear apparatus. The aim of the present disclosure is achieved by the hinge assembly for the smart eyewear apparatus and the smart eyewear apparatus comprising the hinge assembly, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

Embodiments of the present disclosure will now be described, by way of example only, with reference to the following diagrams wherein:
FIG. 1A illustrates an exploded view of a hinge assembly for a smart eyewear apparatus, in accordance with an embodiment of the present disclosure;
FIG. 1B illustrates a top view of an exploded view of a hinge assembly of FIG. 1A for a smart eyewear apparatus, in accordance with an embodiment of the present disclosure;
FIG. 1C illustrates a schematic view of a cam arrangement, in accordance with an embodiment of the present disclosure;
FIG. 2 illustrates a smart eyewear apparatus, in accordance with an embodiment of the present disclosure;
FIG. 3A illustrates a simplified schematic view of an interaction between the rotating member and a spring arranged concentrically around the first hinge of FIG. 1A, in accordance with an embodiment of the present disclosure;
FIG. 3B illustrates a simplified schematic view showing rotation of the rotating member of FIG. 3A in response to an applied force, in accordance with an embodiment of the present disclosure;
FIG. 3C illustrates a simplified schematic view of an interaction between the frame attachment part of FIG. 1A and the first hinge of FIG. 1A, in accordance with an embodiment of the present disclosure;
FIG. 3D illustrates a simplified schematic view showing rotation of the frame attachment part of FIG. 1A in response to an applied force of FIG. 3B, in accordance with an embodiment of the present disclosure;

FIG. 4A illustrates a simplified schematic view showing a cam arrangement in an initial state, in accordance with an embodiment of the present disclosure;

FIG. 4B illustrates a simplified schematic view showing a relative sliding between the first cam surface of FIG. 4A and the second cam surface of FIG. 4A, in accordance with an embodiment of the present disclosure;

FIG. 4C illustrates a simplified schematic view showing loading of a spring by the cam arrangement of FIG. 4A, in accordance with an embodiment of the present disclosure;

FIG. 5A illustrates a simplified schematic view of a hinge assembly showing an electrical conductor routed through the hinge assembly, in accordance with an embodiment of the present disclosure;

FIG. 5B illustrates a simplified schematic view of a charging module electrically connected to the electrical conductor of FIG. 5A, in accordance with an embodiment of the present disclosure;

FIG. 5C illustrates a simplified schematic view of the charging module of FIG. 5A, in accordance with an embodiment of the present disclosure;

FIG. 6 illustrates a simplified schematic view of a hinge assembly showing a frame attachment part configured to be secured to a frame, in accordance with an embodiment of the present disclosure; and

FIG. 7 illustrates a graphical representation showing a relationship between an angular position of a temple about a second hinge and an angular position of a rotating member about a first hinge, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present invention provides a hinge assembly for a smart eyewear apparatus, comprising:
a rotating member;
a first hinge configured to hingedly couple a frame of the smart eyewear apparatus to the rotating member, wherein the first hinge provides a rotation of the frame with respect to the rotating member about a first rotational axis;
a second hinge configured to hingedly couple with a temple of the smart eyewear apparatus to the rotating member, wherein the second hinge provides a rotation of the temple with respect to the rotating member about a second rotational axis;
a frame attachment part configured to couple the rotating member to the frame;
a temple attachment part configured to couple the rotating member to the temple;
a cam arrangement comprising: (i) a first cam surface associated with the frame attachment part, and (ii) a second cam surface associated with the temple attachment part, wherein the first cam surface and the second cam surface are arranged to engage with each other during rotation of the temple; and
a spring arranged concentrically around the first hinge,
wherein a rotation of the temple relative to the frame causes relative sliding between the first cam surface and the second cam surface and loads the spring, and wherein the loaded spring applies a spring force to the rotating member such that the hinge assembly is biased to hold the temple in any one of: a first angular position relative to the frame, a second angular position relative to the frame.

The aforementioned hinge assembly improves positional stability and user experience of the smart eyewear apparatus by reliably biasing the temple to defined angular positions relative to the frame, while ensuring controlled and repeatable movement during operation. The positional stability and controlled movement are achieved since the rotating member cooperates with the first hinge and the second hinge to enable relative rotation of the frame and the temple about the first rotational axis and the second rotational axis, respectively, while the cam arrangement comprising the first cam surface and the second cam surface to produce a guided sliding interaction. The guided sliding interaction between the first cam surface and the second cam surface causes progressive loading of the spring arranged concentrically around the first hinge, such that the spring stores energy during intermediate rotation and applies the spring force to the rotating member. The applied spring force, in combination with the engagement profile of the cam arrangement, biases the hinge assembly to hold the temple in the first angular position or the second angular position relative to the frame, thereby preventing unintended intermediate positions and enabling consistent and stable operation of the hinge assembly.

Throughout the present disclosure, the term “hinge assembly” refers to a mechanical arrangement configured to enable relative movement between the frame and the temple of the smart eyewear apparatus while supporting coordinated interaction between constituent elements to control such movement.

Throughout the present disclosure, the term “smart eyewear apparatus” refers to an eyewear device that is worn by a user and includes at least the frame and the temple configured to be interconnected via the hinge assembly. For example, the smart eyewear apparatus may include the frame configured to support one or more functional elements and the temple configured to extend from the frame, wherein the smart eyewear apparatus enables movement of the temple relative to the frame during usage and storage.

Throughout the present disclosure, the term “rotating member” refers to an intermediate component configured to mechanically couple the frame and the temple via the first hinge and the second hinge, respectively, and to facilitate relative rotation therebetween. For example, the rotating member may be positioned between the frame attachment part and the temple attachment part such that the rotating member enables rotation of the frame about the first rotational axis and rotation of the temple about the second rotational axis.

Throughout the present disclosure, the term “first hinge” refers to a mechanical joint configured to hingedly couple the frame to the rotating member and to permit relative rotational movement between the frame and the rotating member. For example, the first hinge may be configured to allow the frame to rotate with respect to the rotating member about the first rotational axis during operation of the hinge assembly.

Throughout the present disclosure, the term “first rotational axis” refers to an axis about which the frame rotates relative to the rotating member via the first hinge. For example, the first rotational axis may be defined by an alignment of structural features of the first hinge such that the frame undergoes rotational movement about the first rotational axis when the hinge assembly is actuated.

It will be appreciated that the rotation of the frame with respect to the rotating member about the first rotational axis is achieved by the first hinge providing a pivoted connection between the frame and the rotating member such that the frame is allowed to turn relative to the rotating member around a defined axis (namely, the first rotational axis) of rotation. In operation, the first hinge constrains movement of the frame in all directions except rotational movement about the first rotational axis, thereby ensuring that the rotation is controlled and repeatable.

For example, the first hinge may include interfacing portions of the frame and the rotating member that are aligned along the first rotational axis, such that when a user applies a force to the temple, the movement transmitted through the hinge assembly causes the frame to rotate relative to the rotating member about the first rotational axis. In this manner, the first hinge ensures that the frame does not undergo undesired translation or multi-directional movement, but instead follows a defined rotational path.

Such controlled rotation about the first rotational axis is important as it allows the rotating member to coordinate movement between the frame and the temple while maintaining structural alignment of the hinge assembly. Further, by restricting motion to a single rotational degree of freedom at the first hinge, the hinge assembly is able to provide predictable mechanical behaviour, which facilitates effective interaction with the cam arrangement and the spring during operation.

Throughout the present disclosure, the term “second hinge” refers to a mechanical joint configured to hingedly couple the temple to the rotating member and to permit relative rotational movement between the temple and the rotating member. For example, the second hinge may be arranged such that the temple is mounted to the rotating member in a manner that enables the temple to rotate relative to the rotating member during operation of the hinge assembly.

Throughout the present disclosure, the term “temple” refers to an elongate structural component of the smart eyewear apparatus that extends from the frame and is configured to be positioned over or around an ear of the user. For example, the temple may be arranged on either side of the frame and configured to move relative to the frame between an open configuration for wearing and a closed configuration for storage.

Throughout the present disclosure, the term “second rotational axis” refers to an axis about which the temple rotates relative to the rotating member via the second hinge. For example, the second rotational axis may be defined by an alignment of structural portions of the second hinge such that the temple undergoes rotational movement about the second rotational axis when the hinge assembly is actuated.

It will be appreciated that the rotation of the temple with respect to the rotating member about the second rotational axis is achieved by the second hinge providing another pivoted connection between the temple and the rotating member such that the temple is allowed to rotate relative to the rotating member around the second rotational axis. In operation, the second hinge constrains movement of the temple in directions other than rotation about the second rotational axis, thereby ensuring that the movement of the temple is guided and controlled.

For example, when a user opens or closes the smart eyewear apparatus, a force applied to the temple causes the temple to rotate about the second rotational axis relative to the rotating member through the second hinge. In this process, the second hinge maintains alignment between the temple and the rotating member, allowing the temple to follow a defined rotational path without undesired lateral or translational movement.

Such controlled rotation of the temple about the second rotational axis enables coordinated interaction of the temple with the rotating member during operation of the hinge assembly. Further, by allowing the temple to rotate in a predictable manner about the second rotational axis, the second hinge facilitates effective engagement within the hinge assembly, thereby supporting smooth operation and consistent mechanical behaviour of the smart eyewear apparatus.

Throughout the present disclosure, the term “frame attachment part” refers to a structural component configured to mechanically couple the rotating member to the frame, such that movement of the rotating member is transmitted to the frame. For example, the frame attachment part may be arranged between the frame and the rotating member and configured to secure the rotating member relative to the frame, thereby enabling the frame to rotate with respect to the rotating member via the first hinge.

Throughout the present disclosure, the term “temple attachment part” refers to a structural component configured to mechanically couple the rotating member to the temple, such that movement of the rotating member is transmitted to the temple. For example, the temple attachment part may be arranged between the temple and the rotating member and configured to secure the rotating member relative to the temple, thereby enabling the temple to rotate with respect to the rotating member via the second hinge.

Throughout the present disclosure, the term “cam arrangement” refers to a mechanical configuration comprising interacting surfaces configured to guide and control relative movement between components of the hinge assembly through a predefined contact profile. In this regard, the cam arrangement comprises the first cam surface and the second cam surface arranged on respective components such that engagement between the surfaces governs motion within the hinge assembly.

Throughout the present disclosure, the term “first cam surface” refers to a contoured or a profiled surface associated with the frame attachment part, configured to interact with another surface to influence movement during operation of the hinge assembly. For example, the first cam surface may be shaped to define a path along which another surface moves during relative rotation.

Throughout the present disclosure, the term “second cam surface” refers to a profiled surface associated with the temple attachment part, configured to interact with the first cam surface to control relative motion during operation of the hinge assembly. For example, the second cam surface may be arranged to come into contact with the first cam surface during rotation of the temple.

It will be appreciated that the engagement between the first cam surface and the second cam surface during rotation of the temple is achieved by positioning the first cam surface on the frame attachment part and the second cam surface on the temple attachment part such that, when the temple rotates relative to the frame through the second hinge, the relative movement brings the second cam surface into sliding contact with the first cam surface. As the rotation progresses, the shapes of the first cam surface and the second cam surface guide the contact interface along a defined path, thereby converting the rotational motion of the temple into a controlled sliding interaction between the first cam surface and the second cam surface.

For example, when a user rotates the temple from an open position toward a closed position, the second cam surface moves along the contour of the first cam surface, maintaining continuous contact. This sliding engagement ensures that the movement is not free or random, but instead follows a predefined motion profile determined by the geometry of the first cam surface and the second cam surface. Such controlled engagement enables predictable mechanical behaviour within the hinge assembly and supports coordinated interaction with other components during operation.

Throughout the present disclosure, the term “spring” refers to an energy-storing mechanical element arranged concentrically around the first hinge, and configured to generate a restoring force within the hinge assembly in response to deformation caused by relative movement between components relative to the frame.

Throughout the present disclosure, the term “first angular position” refers to a predefined stable orientation of the temple relative to the frame corresponding to a configuration in which the smart eyewear apparatus is arranged for active use by the user. In this position, the temple is maintained in a spatial orientation that supports wearing of the smart eyewear apparatus.

Throughout the present disclosure, the term “second angular position” refers to another predefined stable orientation of the temple relative to the frame corresponding to a configuration in which the smart eyewear apparatus is arranged for storage or non-use. In this position, the temple is maintained in a folded or compact orientation relative to the frame.

It will be appreciated that the loading of the spring and the resulting biasing effect are achieved through coordinated interaction between the rotation of the temple, the cam arrangement, and the rotating member. When the temple is rotated relative to the frame, the movement is transmitted through the temple attachment part to the second cam surface, which slides along the first cam surface associated with the frame attachment part. Due to the profiled geometry of the first cam surface and the second cam surface, this sliding interaction causes a displacement of the rotating member relative to the frame attachment part, thereby inducing deformation in the spring arranged around the first hinge.

As the rotation continues, the deformation of the spring increases, resulting in accumulation of mechanical energy within the spring. When the temple approaches one of the predefined angular positions, the interaction between the first cam surface and the second cam surface alters the displacement behaviour such that the stored energy in the spring is released in a controlled manner. This release of energy applies the spring force to the rotating member, which in turn influences the relative position of the temple and the frame.

Due to this mechanism, the hinge assembly does not remain in arbitrary intermediate orientations. Instead, the combined effect of the cam-guided sliding and the spring-induced restoring force directs the temple toward one of: the first angular position, the second angular position, thereby ensuring that the temple is retained in a stable and repeatable orientation relative to the frame during use and storage.

Optionally, the cam arrangement defines a non-linear relationship between an angular position of the temple about the second hinge and an angular position of the rotating member about the first hinge. Herein, the term “non-linear relationship” refers to a functional interaction between the angular position of the temple about the second hinge and the angular position of the rotating member about the first hinge, wherein a change in the angular position of the temple does not result in a proportional change or an uniform change in the angular position of the rotating member, but instead results in a varying rate of change depending on the relative positions of interacting components.

It will be appreciated that during rotation of the temple about the second hinge, the engagement between the first cam surface and the second cam surface governs how motion is transmitted to the rotating member about the first hinge. Due to the profiled geometry of the first cam surface and the second cam surface, the extent of movement imparted to the rotating member varies across different angular positions of the temple. For example, when the temple is rotated through an intermediate range, the engagement between the first cam surface and the second cam surface may cause a relatively higher displacement of the rotating member for a small angular change of the temple, whereas near predefined angular positions, the same angular change of the temple may result in a comparatively lower displacement of the rotating member. In this manner, the relationship between the angular position of the temple and the angular position of the rotating member is not uniform but varies in a controlled manner, thereby defining the non-linear relationship.

A technical benefit of defining the non-linear relationship between the angular position of the temple about the second hinge and the angular position of the rotating member about the first hinge is that the hinge assembly is able to achieve controlled mechanical response across different stages of operation, wherein resistance to movement and positional biasing may be selectively increased or decreased depending on the angular position. This enables improved stability near predefined positions, smoother transition during intermediate movement, and reduced mechanical stress on the hinge assembly components, thereby enhancing durability and user experience of the smart eyewear apparatus.

Optionally, the rotation of the frame provided by the first hinge lies in a range 0 to 10 degrees. In this regard, the rotation of the frame provided by the first hinge can be for example from 0, 1, 2, 3, 4, 5, 6, 7, or 8 degrees up to and including 4, 5, 6, 7, 8, 9, or 10 degrees. It will be appreciated that a lower bound within the aforementioned range for rotation of the frame facilitates no relative movement of the frame with respect to the rotating member, thereby maintaining structural alignment of the hinge assembly during operation. Further, an upper bound within the aforementioned range enables sufficient angular accommodation to support interaction between the rotating member and the frame during engagement of the cam arrangement and loading of the spring, without introducing excessive displacement that may adversely affect stability of the hinge assembly. The controlled range of rotation of the frame further ensures that the frame remains substantially stable while allowing the rotating member to undergo the necessary motion for coordinated operation of the hinge assembly.

A technical benefit of restricting the rotation of the frame within the aforementioned range is that it enables controlled and limited movement of the frame relative to the rotating member, thereby improving stability and alignment of the hinge assembly while facilitating efficient transmission of motion within the hinge assembly. This results in enhanced durability and consistent performance of the smart eyewear apparatus.

Optionally, the rotation of the temple provided by the second hinge lies in a range 0 to 90 degrees. In this regard, the rotation of the temple about the second rotational axis can be for example from 0, 5, 10, 15, 20, 25, 30, 35, 40, 45, 50, 55, 60, 65, 70, or 75 degrees up to and including 40, 45, 50, 55, 60, 65, 70, 75, 80, 85, or 90 degrees. It will be appreciated that a lower bound within the aforementioned range for the rotation of the temple facilitates positioning of the temple in a configuration suitable for engagement with the frame during initial movement, whereas an upper bound within the aforementioned range enables full folding or extension of the temple relative to the frame to support both usage and storage configurations of the smart eyewear apparatus. The controlled range of rotation of the temple further ensures that the temple undergoes sufficient angular displacement to interact effectively with the cam arrangement and to enable loading of the spring, without exceeding limits that may introduce excessive stress within the hinge assembly.

A technical benefit of defining the rotation of the temple within the aforementioned range is that it enables complete and controlled movement of the temple relative to the frame, thereby supporting reliable transition between different configurations of the smart eyewear apparatus while ensuring effective operation of the hinge assembly and improving durability and experience of the user.

Optionally, the first angular position corresponds to a usage configuration of the smart eyewear apparatus, whereas the second angular position corresponds to a folded or storage configuration of the smart eyewear apparatus. It will be appreciated that the first angular position and the second angular position are defined based on practical configurations of the smart eyewear apparatus during use and non-use. In operation, when the temple is rotated relative to the frame, the interaction between the first cam surface, the second cam surface, and the spring causes the hinge assembly to bias the temple toward discrete stable orientations. For example, when a user wears the smart eyewear apparatus, the temple is rotated outward relative to the frame to a position that allows the smart eyewear apparatus to rest securely on the ears of the user, thereby corresponding to the first angular position. Conversely, when the user removes the smart eyewear apparatus and folds the temple toward the frame for storage, the temple rotates inward to a compact position adjacent to the frame, thereby corresponding to the second angular position. Due to the interaction within the hinge assembly, the temple is guided and retained in these configurations rather than remaining in intermediate orientations.

A technical benefit of associating the first angular position with the usage configuration and the second angular position with the folded or storage configuration is that it enables the hinge assembly to provide defined and repeatable end positions for the temple relative to the frame, thereby improving usability and handling of the smart eyewear apparatus. This ensures that the biasing effect produced by the cam arrangement and the spring results in meaningful and practical positional outcomes, thereby enhancing stability, reducing unintended movement during handling, and improving durability of the hinge assembly during repeated transitions between usage and storage configurations.

Optionally, the hinge assembly further comprises an electrical conductor routed through the hinge assembly. In this regard, the electrical conductor may be implemented, for example, as a flexible printed circuit (FPC), and configured to extend through the hinge assembly while accommodating relative movement between the frame, the rotating member, and the temple. It will be appreciated that the electrical conductor enables transmission of electrical signals and/or power across the hinge assembly while conforming to spatial constraints and movement within the hinge assembly. For example, when the temple is rotated relative to the frame, the electrical conductor undergoes bending and flexing in accordance with movement of the hinge assembly, while maintaining electrical continuity between components of the smart eyewear apparatus. The routing of the electrical conductor through the hinge assembly ensures that the electrical conductor remains contained within the hinge assembly and follows the movement of the hinge assembly without exposure to external elements.

A technical benefit of routing the electrical conductor through the hinge assembly is that it enables reliable electrical connectivity within the smart eyewear apparatus while accommodating repeated mechanical movement of the hinge assembly, thereby improving durability, reducing risk of damage to the electrical conductor, and supporting compact integration of electrical functionality within the smart eyewear apparatus.

Optionally, the electrical conductor is routed through a curved path defined by the first hinge and the second hinge. In this regard, the electrical conductor is routed along the curved path extending through the first hinge and the second hinge, such that the electrical conductor follows a gradual transition between the rotating member, the frame attachment part, and the temple attachment part. It will be appreciated that the curved path is defined by relative spatial arrangement of the first hinge and the second hinge, thereby enabling the electrical conductor to conform to movement of the hinge assembly during rotation of the temple relative to the frame. For example, when the temple is moved between the first angular position and the second angular position, the electrical conductor implemented as the flexible printed circuit flexes along the curved path instead of undergoing sharp directional changes, thereby distributing bending stresses along a larger length of the electrical conductor.

A technical benefit of routing the electrical conductor through the curved path defined by the first hinge and the second hinge is that it minimizes localized bending stresses and mechanical stress within the electrical conductor during operation of the hinge assembly, thereby reducing the likelihood of fatigue or failure and improving long-term reliability of electrical connectivity within the smart eyewear apparatus.

Optionally, the hinge assembly further comprises a charging module integrated within the hinge assembly, wherein the charging module comprises a magnetic element and a plurality of charging pads electrically connected to an electrical conductor. Herein, the term “charging module” refers to an electrical interface arrangement integrated within the hinge assembly and configured to enable transfer of electrical energy between an external power source and the electrical conductor routed through the hinge assembly. For example, the charging module may be positioned within or adjacent to the rotating member such that the charging module facilitates electrical connection without requiring external wiring.

Herein, the term “magnetic element” refers to a component of the charging module configured to generate or interact with a magnetic field to assist in alignment and retention of an external charging interface relative to the charging module. For example, the magnetic element may attract a corresponding element of an external charger to ensure proper positioning of the charging module during a charging operation.

Herein, the term “charging pad” refers to a conductive contact surface of the charging module that is electrically connected to the electrical conductor and configured to establish electrical contact with a corresponding contact of the external charging interface. In this regard, the plurality of charging pads is soldered to the electrical conductor, and filled with glue and/or adhesive for waterproofing purposes. For example, the plurality of charging pads may be arranged in a pattern to enable reliable electrical connection for transfer of electrical energy to the electrical conductor.

It will be appreciated that integration of the charging module within the hinge assembly enables electrical energy to be supplied to the electrical conductor without the need for a separate external connector arrangement. In operation, when the external charging interface is brought into proximity with the hinge assembly, the magnetic element facilitates alignment and retention of the external charging interface relative to the charging module. Upon alignment, the plurality of charging pads comes into contact with corresponding conductive elements of the external charging interface, thereby establishing an electrical connection. The established electrical connection allows electrical energy to be transferred through the charging pads to the electrical conductor, which then distributes the electrical energy within the smart eyewear apparatus. Due to integration within the hinge assembly, the charging module remains mechanically supported and protected during movement of the hinge assembly.

A technical benefit of integrating the charging module within the hinge assembly is that it enables compact and protected electrical charging functionality within the smart eyewear apparatus while reducing reliance on external connectors, thereby improving durability, enhancing user convenience, and maintaining a streamlined structural configuration of the hinge assembly.

Optionally, the first hinge comprises a first pin and a second pin, wherein the second pin is arranged concentrically to the first pin, and wherein the spring is arranged concentrically around the first pin and the second pin. Herein, the term “first pin” refers to a structural element of the first hinge configured to define and support rotational movement of the frame relative to the rotating member about the first rotational axis. For example, the first pin may be implemented as an elongated member aligned along the first rotational axis such that the frame rotates around the first pin during operation of the hinge assembly.

Herein, the term “second pin” refers to another structural element of the first hinge arranged concentrically with respect to the first pin and configured to provide additional mechanical support and alignment within the first hinge. For example, the second pin may be positioned coaxially with the first pin such that both the first pin and the second pin collectively define a stable and reinforced structure for rotational movement within the first hinge.

It will be appreciated that the concentric arrangement of the first pin and the second pin enables the spring to be positioned around both the first pin and the second pin in a manner that aligns the spring with the first rotational axis. In operation, when the temple is rotated relative to the frame, the interaction within the hinge assembly causes movement of the rotating member, which in turn induces deformation in the spring arranged concentrically around the first pin and the second pin. Due to the concentric configuration, the spring deforms uniformly around the first rotational axis, thereby ensuring balanced distribution of mechanical forces. For example, when the temple is moved from one angular position toward another, the spring expands or compresses around the first pin and the second pin without lateral displacement, thereby maintaining alignment and consistent loading behaviour.

A technical benefit of arranging the second pin concentrically to the first pin and positioning the spring concentrically around the first pin and the second pin is that it enables uniform loading and unloading of the spring along the first rotational axis, thereby improving stability, reducing uneven wear within the first hinge. This enhances durability and reliability of the hinge assembly during repeated operation.

Optionally, the second hinge comprises a third pin and a fourth pin, wherein the fourth pin is arranged concentrically to the third pin at a distance from the third pin, and wherein a volume is provided between an end of the third pin and an end of the fourth pin, said end of the third pin and said end of the fourth pin facing towards each other, and wherein an electrical conductor passes through said volume.

Herein, the term “third pin” refers to a structural element of the second hinge configured to support rotational movement of the temple relative to the rotating member about the second rotational axis. For example, the third pin may be implemented as an elongated member aligned along the second rotational axis such that the temple rotates around the third pin during operation of the hinge assembly.

Throughout the present disclosure, the term “fourth pin” refers to another structural element of the second hinge arranged concentrically with respect to the third pin and positioned at the distance from the third pin, such that a spatial gap is defined between the third pin and the fourth pin. For example, the fourth pin may be aligned coaxially with the third pin while being axially offset to define a separation between opposing ends of the third pin and the fourth pin.

It will be appreciated that the arrangement of the third pin and the fourth pin at the distance from each other, while remaining concentrically aligned, creates a defined volume between the facing ends of the third pin and the fourth pin, which is utilized for routing the electrical conductor through the second hinge. In operation, when the temple rotates relative to the frame, the electrical conductor passes through the volume between the third pin and the fourth pin, thereby allowing the electrical conductor to remain within the hinge assembly while accommodating movement. For example, the third pin and the fourth pin may be arranged such that their facing ends define a passage through which the electrical conductor extends from the rotating member toward the temple, thereby avoiding exposure of the electrical conductor outside the hinge assembly. Further, the volume formed between the third pin and the fourth pin allows the electrical conductor to flex within a confined region during rotation of the temple, thereby preventing excessive bending or pinching of the electrical conductor as the temple moves between the first angular position and the second angular position.

A technical benefit of arranging the fourth pin concentrically to the third pin at the distance and providing the volume between the facing ends of the third pin and the fourth pin for routing the electrical conductor is that it enables protected and guided passage of the electrical conductor through the second hinge, thereby reducing mechanical stress on the electrical conductor during operation, improving durability of electrical connectivity, and maintaining compact integration of electrical functionality within the hinge assembly.

Optionally, the spring is implemented as a helical spring. In this regard, the helical spring configured to extend around the first hinge in alignment with the first rotational axis. It will be appreciated that the helical spring is characterized by a coiled structure that allows the spring to compress and expand along the axis of the coil structure in response to applied forces. In operation, when the temple is rotated relative to the frame, the interaction within the hinge assembly causes displacement of the rotating member, which in turn results in axial compression or expansion of the helical spring. Due to the coiled structure, the spring accommodates such deformation in a controlled and repeatable manner while maintaining alignment with the first hinge.

For example, when the temple is moved from the first angular position toward the second angular position, the spring compresses along its axis as the rotating member is displaced, thereby storing mechanical energy. As the temple approaches a predefined angular position, the spring expands to release the stored mechanical energy and apply a restoring force, thereby influencing a positional behaviour of the hinge assembly.

A technical benefit of implementing the spring as the helical spring is that it enables predictable and uniform deformation along the first rotational axis, thereby providing consistent energy storage and release characteristics, improving reliability of the hinge assembly, and enhancing durability during repeated operation.

Optionally, the electrical conductor is electrically connected to at least one spring contact configured to maintain electrical connection during a relative movement within the hinge assembly, the at least one spring contact being arranged at an end of the frame attachment part.

Herein, the term “spring contact” refers to a conductive element configured to provide and maintain electrical connectivity with the electrical conductor while accommodating relative movement within the hinge assembly. For example, the at least one spring contact may be implemented as a resilient conductive member arranged at the end of the frame attachment part such that the spring contact remains in continuous electrical engagement with the electrical conductor despite movement of the rotating member and the temple.

It will be appreciated that the at least one spring contact maintains electrical connection by utilizing its resilient property to adapt to positional changes within the hinge assembly during operation. In operation, when the temple rotates relative to the frame, the movement within the hinge assembly may cause slight displacement between the electrical conductor and the frame attachment part. The at least one spring contact, being arranged at the end of the frame attachment part, flexes or deflects in response to such displacement while remaining in contact with the electrical conductor, thereby ensuring uninterrupted electrical connectivity. For example, when the electrical conductor moves slightly due to rotation of the temple, the at least one spring contact adjusts its position through elastic deformation to maintain contact pressure against the electrical conductor, thereby preventing disconnection.

A technical benefit of providing the at least one spring contact electrically connected to the electrical conductor is that it ensures reliable electrical continuity during relative movement within the hinge assembly, thereby reducing the risk of intermittent electrical connection, improving operational reliability, and enhancing durability of the smart eyewear apparatus.

Optionally, the frame attachment part is configured to be secured to the frame by employing a press-fit and a fastener. Herein, the term “press-fit” refers to a mechanical securing technique in which the frame attachment part is inserted into or engaged with a corresponding portion of the frame with an interference fit such that frictional forces between contacting surfaces retain the frame attachment part in position without requiring additional clearance. For example, the frame attachment part may be dimensioned slightly larger than a corresponding receiving portion of the frame such that, upon insertion, the frame attachment part is held securely in place due to the friction generated between the contacting surfaces.

Herein, the term “fastener” refers to another mechanical securing element configured to fix the frame attachment part to the frame by providing additional retention force to prevent relative movement between the frame attachment part and the frame. For example, the fastener may be implemented as a screw, a rivet, or similar element that passes through aligned portions of the frame attachment part and the frame to lock the frame attachment part in position.

It will be appreciated that the frame attachment part is secured to the frame by combining the press-fit and the fastener such that the press-fit provides initial alignment and retention during assembly, while the fastener reinforces the connection to prevent loosening during operation of the hinge assembly. For example, during assembly of the smart eyewear apparatus, the frame attachment part may first be inserted into the frame using the press-fit to achieve proper positioning, and subsequently the fastener may be applied to ensure long-term stability of the connection under repeated movement of the hinge assembly.

A technical benefit of securing the frame attachment part to the frame using the press-fit and the fastener is that it provides a robust and a stable mechanical connection capable of withstanding repeated rotational movement within the hinge assembly, thereby improving durability, maintaining alignment of the hinge assembly, and enhancing overall reliability of the smart eyewear apparatus.

In a second aspect, an embodiment of the present invention provides a smart eyewear apparatus comprising:
a frame configured to accommodate therein at least one lens per eye;
a first temple and a second temple;
a first hinge assembly of the first aspect, for hingedly coupling the first temple to the frame; and
a second hinge assembly of the first aspect, for hingedly coupling the second temple to the frame.

The aforementioned smart eyewear apparatus improves overall stability, usability, and durability by incorporating the first hinge assembly and the second hinge assembly to enable controlled and coordinated movement of the first temple and the second temple relative to the frame, while maintaining consistent mechanical behaviour on both sides of the frame. The improved stability and coordinated movement are achieved since the first hinge assembly and the second hinge assembly are configured to hingedly couple the first temple and the second temple to the frame in a symmetrical manner, such that movement of each of the first temple and the second temple is governed by corresponding hinge assemblies. Each hinge assembly provides controlled rotation of the respective temple relative to the frame, thereby ensuring that both the first temple and the second temple are biased toward defined angular positions during operation. The use of the first hinge assembly and the second hinge assembly further ensures that mechanical forces generated during movement are distributed across both sides of the frame, thereby reducing localized stress and enabling balanced operation of the smart eyewear apparatus.

Such coordinated operation of the first hinge assembly and the second hinge assembly enables the smart eyewear apparatus to maintain consistent positioning of the first temple and the second temple relative to the frame, thereby preventing uneven movement or misalignment. This results in improved user comfort during wearing and reliable folding during storage, while also enhancing durability of the smart eyewear apparatus due to uniform load distribution and reduced mechanical wear.

Herein, the term “lens” refers to an optical element supported by the frame and configured to influence transmission of light toward an eye of the user. In this regard, the frame is configured to accommodate the at least one lens per eye of the user.

The present invention also relates to the smart eyewear apparatus as described above. Various embodiments and variants disclosed above, with respect to the aforementioned first aspect (namely, the hinge assembly), apply mutatis mutandis to the second aspect (namely, the smart eyewear apparatus).

Optionally, the at least one lens is implemented as at least one adaptive lens, and wherein the smart eyewear apparatus further comprises:
(i) a power source that supplies electricity to the at least one adaptive lens; and
(ii) a controller configured to control an optical power produced by the at least one adaptive lens.

It will be appreciated that the at least one lens is implemented as the at least one adaptive lens capable of varying an optical property in response to an electrical input. For example, the at least one adaptive lens may be configured to change an optical power in response to a control signal, thereby enabling dynamic adjustment of vision correction or visual output during use of the smart eyewear apparatus, by the user.

Herein, the term “power source” refers to an electrical component configured to supply electrical energy to one or more elements of the smart eyewear apparatus, including the at least one adaptive lens. For example, the power source may be arranged within the smart eyewear apparatus such that the power source provides electrical energy to the at least one adaptive lens through the electrical conductor to enable operation of the at least one adaptive lens.

Herein, the term “controller” refers to an electronic unit configured to regulate operation of the at least one adaptive lens by controlling the optical power produced by the at least one adaptive lens in response to one or more inputs. For example, the controller may generate control signals based on predefined settings or external inputs to adjust the optical power of the at least one adaptive lens.

It will be appreciated that the at least one adaptive lens operates in coordination with the power source and the controller to dynamically modify optical characteristics during use of the smart eyewear apparatus. In operation, the power source supplies electrical energy to the at least one adaptive lens, while the controller regulates the supplied electrical energy to control the optical power of the at least one adaptive lens. For example, when a user requires a change in optical correction, the controller adjusts the electrical input to the at least one adaptive lens, thereby causing the at least one adaptive lens to vary its optical power accordingly.

A technical benefit of implementing the at least one lens as the at least one adaptive lens in combination with the power source and the controller is that it enables dynamic and controlled adjustment of the optical power within the smart eyewear apparatus, thereby improving visual performance, enhancing user adaptability, and enabling advanced functionality without requiring manual replacement or adjustment of the at least one lens.

### DETAILED DESCRIPTION OF THE DRAWINGS

Referring to FIG. 1A, illustrated is an exploded view of a hinge assembly 100 for a smart eyewear apparatus (shown later in FIG. 2), in accordance with an embodiment of the present disclosure. The hinge assembly 100 comprises:
a rotating member 102;
a first hinge 104 configured to hingedly couple a frame (shown later in FIG. 2) of the smart eyewear apparatus to the rotating member 102,
wherein the first hinge 104 provides a rotation of the frame with respect to the rotating member 102 about a first rotational axis 106;
a second hinge 108 configured to hingedly couple with a temple (shown later in FIG. 2) of the smart eyewear apparatus to the rotating member 102, wherein the second hinge 108 provides a rotation of the temple with respect to the rotating member 102 about a second rotational axis 110;
a frame attachment part 112 configured to couple the rotating member 102 to the frame;
a temple attachment part 114 configured to couple the rotating member 102 to the temple;
a cam arrangement (shown later in FIG. 1C) comprising: (i) a first cam surface (shown later in FIG. 1C) associated with the frame attachment part 112, and (ii) a second cam surface (shown later in FIG. 1C) associated with the temple attachment part 114, wherein the first cam surface and the second cam surface are arranged to engage with each other during rotation of the temple; and
a spring 116 arranged concentrically around the first hinge 104,
wherein a rotation of the temple relative to the frame causes relative sliding between the first cam surface and the second cam surface and loads the spring 116, and wherein the loaded spring applies a spring force to the rotating member 102 such that the hinge assembly 100 is biased to hold the temple in any one of: a first angular position relative to the frame, a second angular position relative to the frame.

Optionally, the hinge assembly 100 further comprises an electrical conductor 118 routed through the hinge assembly 100. Optionally, the hinge assembly 100 further comprises a charging module 120 integrated within the hinge assembly 100. The charging module 120 comprises a magnetic element 122 and a plurality of charging pads (for example, depicted as a charging pad 124) electrically connected to the electrical conductor 118.

Optionally, the first hinge 104 comprises a first pin 126 and a second pin 128, wherein the second pin 128 is arranged concentrically to the first pin 126, and wherein the spring 116 is arranged concentrically around the first pin 126 and the second pin 128.

Optionally, the second hinge 108 comprises a third pin 130 and a fourth pin 132, wherein the fourth pin 132 is arranged concentrically to the third pin 130 at a distance from the third pin 130, and wherein a volume is provided between an end of the third pin 130 and an end of the fourth pin 132, said end of the third pin 130 and said end of the fourth pin 132 facing towards each other, and wherein the electrical conductor 118 passes through said volume.

Optionally, the electrical conductor 118 is electrically connected to at least one spring contact (for example, depicted as a spring contact 134) configured to maintain electrical connection during a relative movement within the hinge assembly 100, the at least one spring contact 134 being arranged at an end of the frame attachment part 112.

Referring to FIG. 1B, illustrated is a top view of an exploded view of a hinge assembly 100 (of FIG. 1A) for a smart eyewear apparatus (shown later in FIG. 1D), in accordance with an embodiment of the present disclosure.

Referring to FIG. 1C, illustrated is a schematic view of a cam arrangement 136, in accordance with an embodiment of the present disclosure. The cam arrangement 136 comprises: (i) a first cam surface 138 associated with the frame attachment part 112, and (ii) a second cam surface 140 associated with the temple attachment part 114, wherein the first cam surface 138 and the second cam surface 140 are arranged to engage with each other during rotation of the temple.

FIGS. 1A, 1B and 1C are merely examples, which should not unduly limit the scope of the claims herein. The person skilled in the art will recognize many variations, alternatives, and modifications of embodiments of the present disclosure.

Referring to FIG. 2, illustrated is a smart eyewear apparatus 200, in accordance with an embodiment of the present disclosure. The smart eyewear apparatus 200 comprises:
a frame 202 configured to accommodate therein at least one lens (for example, depicted as lenses 204a and 204b) per eye;
a first temple 206a and a second temple 206b;
a first hinge assembly 208a, for hingedly coupling the first temple 206a to the frame 202; and
a second hinge assembly 208b, for hingedly coupling the second temple 206b to the frame 202.

FIG. 2 is merely an example, which should not unduly limit the scope of the claims herein. The person skilled in the art will recognize many variations, alternatives, and modifications of embodiments of the present disclosure.

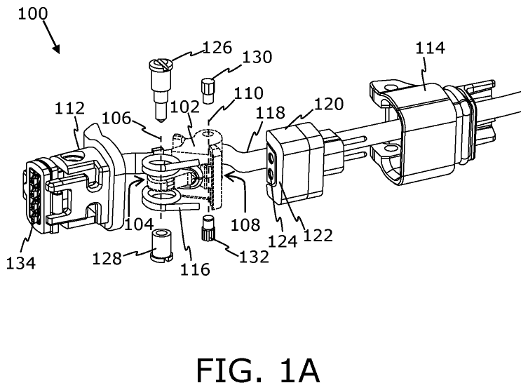

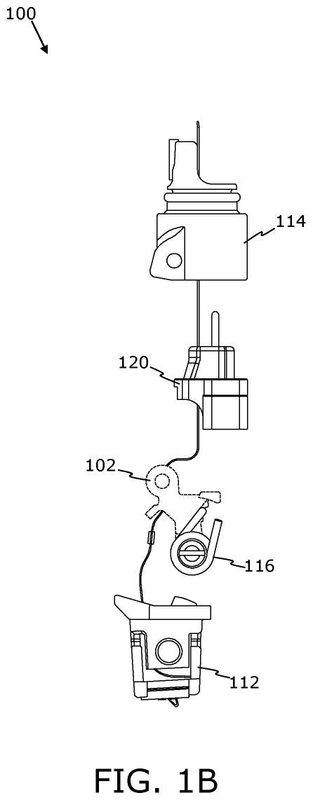

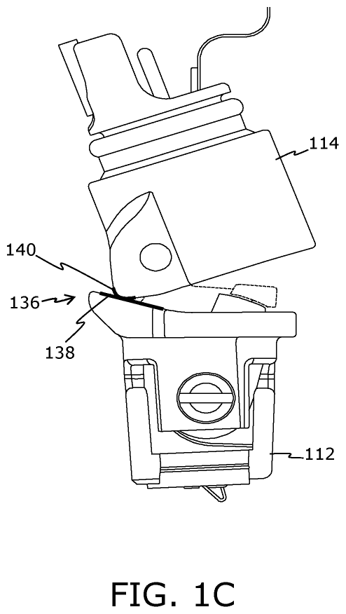

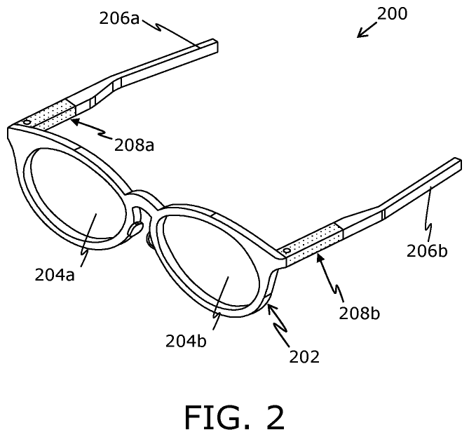

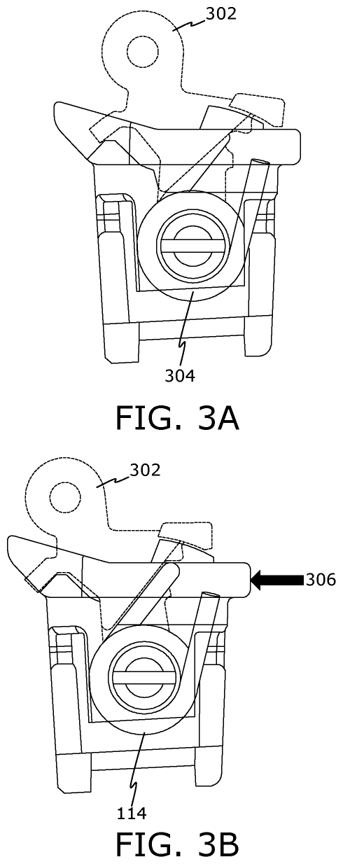

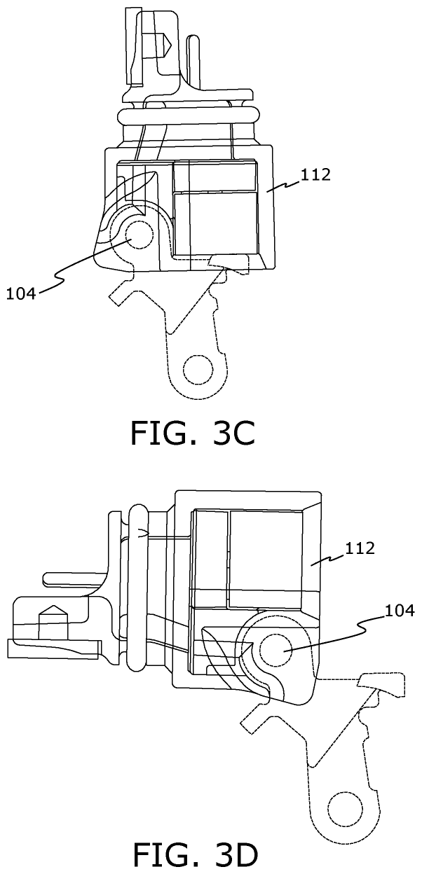

Referring to FIG. 3A, illustrated is a simplified schematic view of an interaction between the rotating member 302 and the spring 304 arranged concentrically around the first hinge 104 of FIG. 1A, in accordance with an embodiment of the present disclosure. As shown, the rotating member 302 is arranged in an initial state corresponding to a first angular position, wherein the rotating member 302 is maintained at the initial state about the first rotational axis 106 of FIG. 1A.

Referring to FIG. 3B, illustrated is a simplified schematic view showing rotation of the rotating member 302 in response to an applied force 306, in accordance with an embodiment of the present disclosure. As shown, the applied force 306 causes rotation of the rotating member 302 about the first rotational axis 106 of FIG. 1A corresponding to a second angular position, thereby causing loading of the spring 304 arranged concentrically around the first hinge 104.

It will be appreciated that, the rotation of the rotating member 302 about the first rotational axis 106 lies in a range from 0 degrees to 10 degrees.

Referring to FIG. 3C, illustrated is a simplified schematic view of an interaction between the frame attachment part 112 of FIG. 1A and the first hinge 104 of FIG. 1A, in accordance with an embodiment of the present disclosure. As shown, the frame attachment part 112 is arranged in an initial state corresponding to the first angular position, wherein the frame attachment part 112 is maintained at the initial state about the second rotational axis 110 of FIG. 1A.

Referring to FIG. 3D, illustrated is a simplified schematic view showing rotation of the frame attachment part 112 in response to an applied force 306 of FIG. 3B, in accordance with an embodiment of the present disclosure. As shown, the applied force 306 causes rotation of the frame attachment part 112 about the first rotational axis 106 of FIG. 1A relative to the first hinge 104 of FIG. 1A. This causes to the frame attachment part 112 is to be arranged in a final state corresponding to the second angular position, wherein the frame attachment part 112 is maintained at the initial state about the second rotational axis 110 of FIG. 1A.

It will be appreciated that, the rotation of the frame attachment part 112 about the second rotational axis 110 lies in a range from 0 degrees to 90 degrees.

FIGS. 3A, 3B, 3C and 3D are merely examples, which should not unduly limit the scope of the claims herein. The person skilled in the art will recognize many variations, alternatives, and modifications of embodiments of the present disclosure.

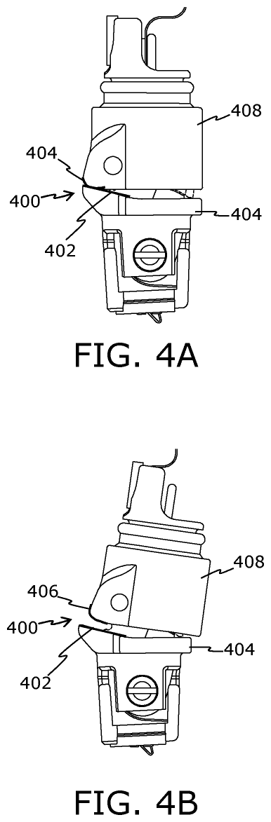

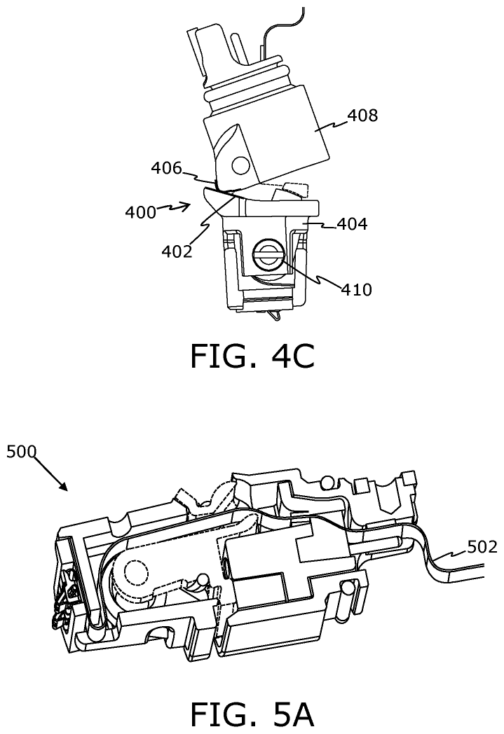

Referring to FIG. 4A, illustrated is a simplified schematic view showing a cam arrangement 400 in an initial state, in accordance with an embodiment of the present disclosure. As shown, the first cam surface 402 is associated with the frame attachment part 404 and the second cam surface 406 is associated with the temple attachment part 408 are arranged to engage with each other at the first angular position relative to the frame 202 of FIG. 2.

Referring to FIG. 4B, illustrated is a simplified schematic view showing a relative sliding between the first cam surface 402 and the second cam surface 406, in accordance with an embodiment of the present disclosure. As shown, rotation of the temple 206a and 206b of FIG. 2 relative to the frame 202 of FIG. 2 causes the relative sliding between the first cam surface 402 and the second cam surface 406.

Referring to FIG. 4C, illustrated is a simplified schematic view showing loading of a spring 410 by the cam arrangement 400, in accordance with an embodiment of the present disclosure. As shown, the relative sliding between the first cam surface 402 and the second cam surface 406 causes the rotating member 102 of FIG. 1A to move against the spring 410, thereby loading the spring 410.

FIGS. 4A, 4B and 4C are merely examples, which should not unduly limit the scope of the claims herein. The person skilled in the art will recognize many variations, alternatives, and modifications of embodiments of the present disclosure.

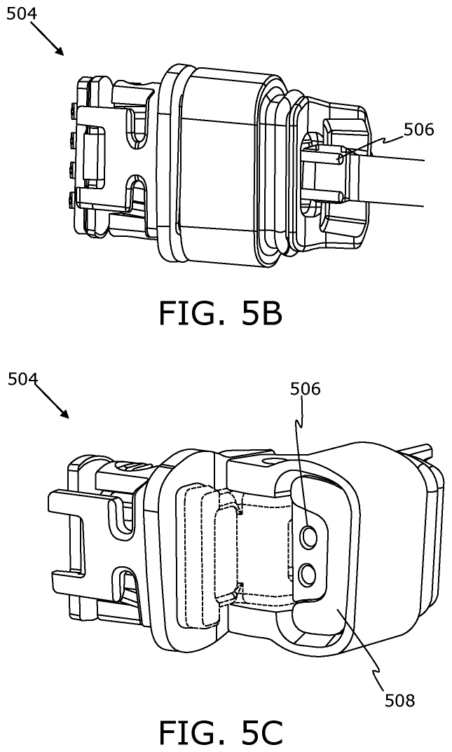

Referring to FIG. 5A, illustrated is a simplified schematic view of a hinge assembly 500 showing an electrical conductor 502 routed through the hinge assembly 500, in accordance with an embodiment of the present disclosure. As shown, the electrical conductor 502 is implemented as the flexible printed circuit (FPC) extending through the hinge assembly 500 to maintain electrical connectivity across the hinge assembly 500 during movement of the rotating member 102 of FIG. 1A, the frame attachment part 112 of FIG. 1A, and the temple attachment part 114 of FIG. 1A.

Referring to FIG. 5B, illustrated is a simplified schematic view of a charging module 504 electrically connected to the electrical conductor 502 of FIG. 5A, in accordance with an embodiment of the present disclosure. As shown, the charging module 504 comprises a plurality of charging pads (for example, depicted as a charging pad 506) electrically connected to the electrical conductor 502, which is implemented as the flexible printed circuit (FPC). Further, the plurality of charging pads 506 are soldered to the electrical conductor 502 and filled with glue or adhesive for waterproofing purposes.

Referring to FIG. 5C, illustrated is a simplified schematic view of the charging module 504 of FIG. 5A, in accordance with an embodiment of the present disclosure. As shown, the charging module 504 comprises a magnetic element 508 and a plurality of charging pads 506 configured to establish the electrical connection with an external charging interface.

FIGS. 5A, 5B and 5C are merely examples, which should not unduly limit the scope of the claims herein. The person skilled in the art will recognize many variations, alternatives, and modifications of embodiments of the present disclosure.

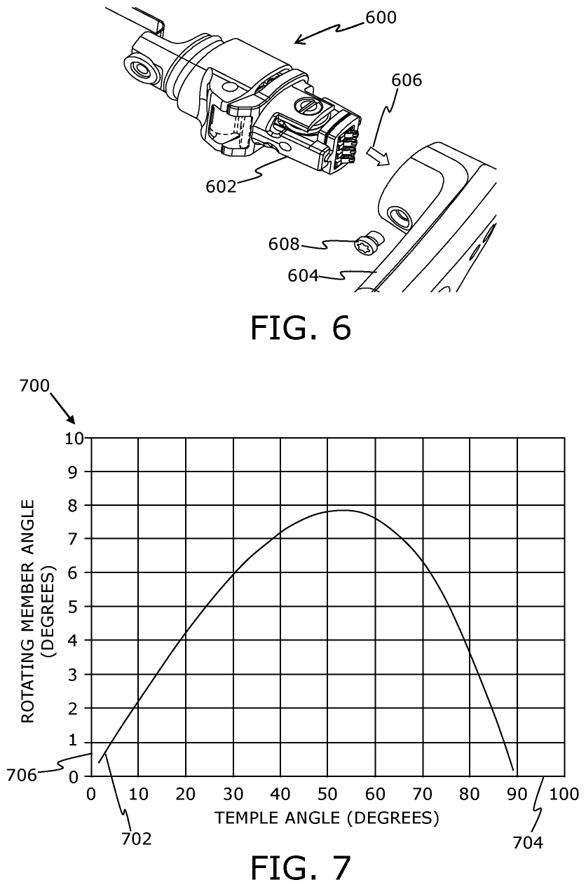

Referring to FIG. 6, illustrated is a simplified schematic view of a hinge assembly 600 showing a frame attachment part 602 configured to be secured to a frame 604, in accordance with an embodiment of the present disclosure. As shown, the frame attachment part 602 is configured to be inserted into the frame 604 using a press-fit by applying a force 606 and secured to the frame 604 using a fastener 608.

FIG. 6 is merely an example, which should not unduly limit the scope of the claims herein. The person skilled in the art will recognize many variations, alternatives, and modifications of embodiments of the present disclosure.

Referring to FIG. 7, illustrated is a graphical representation 700 showing a relationship between an angular position of a temple about a second hinge and an angular position of a rotating member about a first hinge, in accordance with an embodiment of the present disclosure. As shown, the graphical representation 700 defines a non-linear relationship 702 between the angular position of the temple represented along an X-axis 704 and the angular position of the rotating member represented along a Y-axis 706.

Further, the graphical representation 700 illustrates that the rotation of the temple about the second hinge lies in a range from 0 degrees to 90 degrees, whereas the rotation of the rotating member about the first hinge lies in a range from 0 degrees to 10 degrees. As shown, variation in the angular position of the temple causes corresponding non-linear variation in the angular position of the rotating member during operation of the hinge assembly.

FIG. 7 is merely an example, which should not unduly limit the scope of the claims herein. The person skilled in the art will recognize many variations, alternatives, and modifications of embodiments of the present disclosure.

1. A hinge assembly for a smart eyewear apparatus, comprising:
a rotating member;
a first hinge configured to hingedly couple a frame of the smart eyewear apparatus to the rotating member, wherein the first hinge provides a rotation of the frame with respect to the rotating member about a first rotational axis;
a second hinge configured to hingedly couple with a temple of the smart eyewear apparatus to the rotating member, wherein the second hinge provides a rotation of the temple with respect to the rotating member about a second rotational axis;
a frame attachment part configured to couple the rotating member to the frame;
a temple attachment part configured to couple the rotating member to the temple;
a cam arrangement comprising: (i) a first cam surface associated with the frame attachment part, and (ii) a second cam surface associated with the temple attachment part, wherein the first cam surface and the second cam surface are arranged to engage with each other during rotation of the temple; and
a spring arranged concentrically around the first hinge,
wherein a rotation of the temple relative to the frame causes relative sliding between the first cam surface and the second cam surface and loads the spring, and wherein the loaded spring applies a spring force to the rotating member such that the hinge assembly is biased to hold the temple in any one of: a first angular position relative to the frame, a second angular position relative to the frame.

2. The hinge assembly of claim 1, the cam arrangement defines a non-linear relationship between an angular position of the temple about the second hinge and an angular position of the rotating member about the first hinge.

3. The hinge assembly of claim 1, wherein the rotation of the frame provided by the first hinge lies in a range 0 to 10 degrees.

4. The hinge assembly of claim 1, wherein the rotation of the temple provided by the second hinge lies in a range 0 to 90 degrees.

5. The hinge assembly of claim 1, wherein the first angular position corresponds to a usage configuration of the smart eyewear apparatus, whereas the second angular position corresponds to a folded or storage configuration of the smart eyewear apparatus.

6. The hinge assembly of claim 1, further comprising an electrical conductor routed through the hinge assembly.

7. The hinge assembly of claim 5, wherein the electrical conductor is routed through a curved path defined by the first hinge and the second hinge.

8. The hinge assembly of claim 1, further comprising a charging module integrated within the hinge assembly, wherein the charging module comprises a magnetic element and a plurality of charging pads electrically connected to an electrical conductor.

9. The hinge assembly of claim 1, wherein the first hinge comprises a first pin and a second pin, wherein the second pin is arranged concentrically to the first pin, and wherein the spring is arranged concentrically around the first pin and the second pin.

10. The hinge assembly of claim 1, wherein the second hinge comprises a third pin and a fourth pin, wherein the fourth pin is arranged concentrically to the third pin at a distance from the third pin, and wherein a volume is provided between an end of the third pin and an end of the fourth pin, said end of the third pin and said end of the fourth pin facing towards each other, and wherein an electrical conductor passes through said volume.

11. The hinge assembly of claim 1, wherein the spring is implemented as a helical spring.

12. The hinge assembly of claim 1, wherein the electrical conductor is electrically connected to at least one spring contact configured to maintain electrical connection during a relative movement within the hinge assembly, the at least one spring contact being arranged at an end of the frame attachment part.

13. The hinge assembly of claim 1, wherein the frame attachment part is configured to be secured to the frame by employing a press-fit and a fastener.

14. A smart eyewear apparatus comprising:
a frame configured to accommodate therein at least one lens per eye;
a first temple and a second temple;
the first hinge assembly according to claim 1, for hingedly coupling the first temple to the frame; and
the second hinge assembly according to claim 1, for hingedly coupling the second temple to the frame.

15. The smart eyewear apparatus of claim 14, wherein the at least one lens is implemented as at least one adaptive lens, and wherein the smart eyewear apparatus further comprises:
(i) a power source that supplies electricity to the at least one adaptive lens; and
(ii) a controller configured to control an optical power produced by the at least one adaptive lens.
